(19) United States
(12) Patent Application Publication
(10) Pub. No.: US 2026/0357103 A1
(43) Pub. Date: Nov. 12, 2026

(54) ONE-PACK CURABLE COMPOSITION

(71) Applicant: Sunstar Engineering Inc., Osaka (JP)

(72) Inventors: Takahiro MURATA, Osaka (JP); Atsushi UNO, Osaka (JP)

(73) Assignee: Sunstar Engineering Inc., Osaka (JP)

(21) Appl. No.: 19/122,527

(22) PCT Filed: Oct. 6, 2023
(86) PCT No.: PCT/JP2023/036591

§ 371 Date: Apr. 18, 2025

(30) Foreign Application Priority Data
Nov. 1, 2022 (JP) 2022-175739

(51) Int. Cl. C09D 163/00; C09D 7/40

(52) U.S. Cl. CPC C09D 163/00; C09D 7/70

(57) ABSTRACT

Disclosed is a one-pack curable composition, comprising: (A) an epoxy resin; (B) a solid rubber; (C) a latent curing agent; (D) a filler; and (E) a foaming agent, wherein the epoxy resin (A) comprises an unmodified bisphenol-type epoxy resin (A1), the one-pack curable composition comprises 10 to 100 parts by mass of the solid rubber (B) per 100 parts by mass of the epoxy resin (A), and the solid rubber (B) comprises a styrene-butadiene-divinylbenzene copolymer (B1).

### TECHNICAL FIELD

The present invention relates to a one-pack curable composition, more particularly a coating-type one-pack curable composition that comprises (A) an epoxy resin, (B) a solid rubber, (C) a latent curing agent, (D) a filler, and (E) a foaming agent.

### BACKGROUND ART

Thinned sheet metals are used for weight reduction of automobile bodies. Sheet metal reinforcing materials are used for the purpose of ensuring the tensional rigidity and the dent properties of such sheet metals. Usually, sheet metal reinforcing materials have a three-layer structure consisting of a glass cloth, an adhesive, and a release paper, and are marketed as standard products having a certain plate-like shape. Such sheet metal reinforcing materials (standard products) are used after being adjusted to a desired shape. Shape-adjusted sheet metal reinforcing materials are attached to sheet metals; however, this process requires correction by a person (worker) due to deterioration of adhesiveness, misalignment of attachment position, and the like that are caused by the use environment. Thus, it is difficult to achieve full automation of sheet metal reinforcement with the use of a sheet metal reinforcing material (standard product), and this inevitably leads to a productivity decline. In addition, the disposal of the above-described release paper may lead to an increase in cost, environmental load due to waste generation, and the like. Therefore, there are demands for a sheet metal reinforcing material that enables full automation. As such a sheet metal reinforcing material, those that can be automatically applied have been studied.

For example, Patent Document 1 discloses a coating-type sheet metal reinforcing material composition based on a high-viscosity viscous material obtained by blending a liquid composition of a thermosetting epoxy resin with an inorganic filler having a specific aspect ratio (L/D). Patent Document 1 discloses that the coating-type sheet metal reinforcing material composition can be applied with heating and, during the process prior to curing and baking, cooling solidification of the applied composition not only prevents scattering, dissolution, and detachment of the composition in a chemical conversion treatment liquid or an electrolyte solution to improve the shower resistance in particular as well as the bending strength and the rigidity of a sheet metal in terms of the reinforcing effect, but also inhibits distortion of the sheet metal even after curing (see [0005] of Patent Document 1).

### PRIOR ART DOCUMENT

### Patent Document

Patent Document 1: Japanese Patent No. 3547404

### SUMMARY OF THE INVENTION

### Problems to be Solved by the Invention

The coating-type sheet metal reinforcing material disclosed in Patent Document 1 has excellent properties, and it is demanded to improve the reinforcing performance while reducing strain and to improve the shower resistance while maintaining pump dischargeability. However, in Patent Document 1, the coating-type sheet metal reinforcing material is obtained by preparing a high-viscosity viscous material, and Patent Document 1 does not offer any teaching with regard to improving the bending strength, improving the shower resistance, or maintaining a low viscosity and pump dischargeability.

In view of the above, an object of the present invention is to provide a one-pack curable composition which can be applied with heating while maintaining a low viscosity, but is not scattered, dissolved, or detached particularly in a shower of water, a chemical conversion treatment liquid, or an electrodeposition liquid during the process from application to curing and baking, and improves the bending strength and the rigidity of a sheet metal after being cured but does not cause a strain on the sheet metal.

### Solutions to the Problems

The present inventors intensively studied to discover that a one-pack curable composition, which not only can improve the reinforcing performance while reducing strain but also can improve the shower resistance while maintaining pump dischargeability, can be obtained by using a specific solid rubber of styrene-butadiene-divinylbenzene copolymer, and a foaming agent. The present inventors also discovered that such a one-pack curable composition can be preferably applied to a sheet metal, and can thus be preferably used as a coating-type sheet metal reinforcing material, thereby completing the present invention.

The present specification encompasses the following embodiments.

1. A one-pack curable composition, comprising:
(A) an epoxy resin;
(B) a solid rubber;
(C) a latent curing agent;
(D) a filler; and
(E) a foaming agent,
wherein
the epoxy resin (A) comprises an unmodified bisphenol-type epoxy resin (A1),
the one-pack curable composition comprises 10 to 100 parts by mass of the solid rubber (B) per 100 parts by mass of the epoxy resin (A), and
the solid rubber (B) comprises a styrene-butadiene-divinylbenzene copolymer (B1).

2. The one-pack curable composition according to 1, having a viscosity of 50 to 300 Pa·s at a temperature of 40 °C and a shear rate of 430 sec⁻¹.

3. The one-pack curable composition according to 1 or 2, wherein the epoxy resin (A) comprises 25 to 90% by mass of the unmodified bisphenol-type epoxy resin (A1) based on 100% by mass of the epoxy resin.

4. The one-pack curable composition according to any one of 1 to 3, wherein the epoxy resin (A) comprises 15 to 40% by mass of an aromatic ring based on 100% by mass of the epoxy resin.

5. The one-pack curable composition according to any one of 1 to 4, wherein the foaming agent (E) comprises at least one selected from the group consisting of ADCA-type chemical foaming agents, OBSH-type chemical foaming agents, and unexpanded balloons.

6. The one-pack curable composition according to any one of 1 to 5, having a foaming ratio of 10 to 200%.

7. The one-pack curable composition according to any one of 1 to 6, wherein the filler (D) comprises a needle-like filler having a length of 0.5 mm or more.

8. The one-pack curable composition according to any one of 1 to 7, wherein the solid rubber (B) further comprises a styrene-butadiene copolymer (B2).

9. The one-pack curable composition according to any one of 1 to 8, wherein the solid rubber (B) further comprises a nitrile-butadiene copolymer (B3).

10. The one-pack curable composition according to any one of 1 to 9, wherein the solid rubber (B1) and/or the solid rubber (B2) have an acid content of 0.2 to 8% by mass.

11. The one-pack curable composition according to any one of 1 to 10, wherein
the epoxy resin (A) comprises a low-viscosity epoxy resin (A2), and
the low-viscosity epoxy resin (A2) has an epoxy equivalent of 250 to 700, and a viscosity of 40 to 5,000 mPa·s at 25 °C.

12. The one-pack curable composition according to 11, wherein the low-viscosity epoxy resin (A2) comprises a dibasic acid ester-type epoxy resin (A2-1).

13. The one-pack curable composition according to any one of 1 to 12, wherein the filler (D) comprises an inorganic filler having an aspect ratio (L/D) of 5 or higher.

14. The one-pack curable composition according to any one of 1 to 13, which is of a coating type.

15. The one-pack curable composition according to any one of 1 to 14, which is used for sheet metal reinforcement and is pump-dischargeable.

### Effects of the Invention

The one-pack curable composition according to one embodiment of the present invention not only can improve the reinforcing performance while reducing strain but also can improve the shower resistance while maintaining pump dischargeability. Further, the one-pack curable composition can be preferably applied to a sheet metal, and can thus be preferably used as a coating-type sheet metal reinforcing material.

### DETAILED DESCRIPTION

One aspect of the present specification provides a one-pack (or one-liquid) curable composition comprising an epoxy resin (A), a solid rubber (B), a latent curing agent (C), a filler (D), and a foaming agent (E).

In this one-pack curable composition,
the epoxy resin (A) comprises an unmodified bisphenol-type epoxy resin (A1),
the one-pack curable composition comprises 10 to 100 parts by mass of the solid rubber (B) per 100 parts by mass of the epoxy resin (A), and
the solid rubber (B) comprises a styrene-butadiene-divinylbenzene copolymer (B1).

In the present specification, the “epoxy resin (A)” refers to a thermosetting resin that can be cured as a result of the generation of a crosslinked network by the epoxy groups existing therein and is generally called an epoxy resin, and the epoxy resin (A) is not particularly limited as long as the curable composition intended by the present invention can be obtained.

The epoxy resin (A) may be, for example, a glycidyl ether-type epoxy resin, a glycidylamine-type epoxy resin, or a glycidyl ester-type epoxy resin.

The epoxy resin (A) preferably comprises an unmodified bisphenol-type epoxy resin (A1).

The unmodified bisphenol-type epoxy resin (A1) is an epoxy resin having a bisphenol skeleton, and is not particularly limited as long as it is not modified in particular and the epoxy resin composition intended by the present invention can be obtained.

Examples of the unmodified bisphenol-type epoxy resin (A1) comprise diglycidyl ethers of bisphenol A, bisphenol F, brominated bisphenol A, and bisphenol AD.

The unmodified bisphenol-type epoxy resin (A1) has a viscosity at 25 °C of preferably 1,500 mPa·s or more, more preferably 2,000 to 25,000 mPa·s, still more preferably 2,500 to 20,000 mPa·s, yet still more preferably 3,000 to 15,000 mPa·s.

The unmodified bisphenol-type epoxy resin (A1) has an epoxy equivalent of preferably 150 to 800 g/eq, more preferably 160 to 500 g/eq, still more preferably 165 to 250 g/eq, yet still more preferably 170 to 200 g/eq. The unmodified bisphenol-type epoxy resin (A1) has superior workability when the epoxy equivalent is 150 to 800 g/eq.

As the unmodified bisphenol-type epoxy resin (A1), a commercially available product can be used. Examples thereof comprise “jER (registered trademark) 828”, “jER (registered trademark) 1001”, and “jER (registered trademark) 807”, which are manufactured by Mitsubishi Chemical Corporation.

The epoxy resin (A) may comprise the unmodified bisphenol-type epoxy resin (A1) in an amount of preferably 25 to 90% by mass or 25 to 60% by mass, more preferably 29 to 80% by mass or 29 to 56% by mass, still more preferably 33 to 65% by mass, yet still more preferably 33 to 52% by mass, further preferably 35 to 49% by mass, based on 100% by mass of the epoxy resin.

When the epoxy resin (A) comprises 25 to 90% by mass of the unmodified bisphenol-type epoxy resin (A1) based on 100% by mass of the epoxy resin, the Tg, the elastic modulus, and the bending strength of the curable composition according to one embodiment of the present invention can be improved in a more balanced manner.

The epoxy resin (A) may comprise a low-viscosity epoxy resin (A2). The “low-viscosity epoxy resin (A2)” refers to an epoxy resin having a viscosity of less than 5,000 mPa·s at 25 °C, and the low-viscosity epoxy resin (A2) has a viscosity of preferably 40 to 5,000 mPa·s, more preferably 45 to 4,000 mPa·s, still more preferably 50 to 3,000 mPa·s, yet still more preferably 60 to 2,500 mPa·s.

When the epoxy resin (A) comprises the low-viscosity epoxy resin (A2), the curable composition according to one embodiment of the present invention can ensure pump dischargeability at relatively low temperatures (40 to 50 °C).

The low-viscosity epoxy resin (A2) has an epoxy equivalent of preferably 250 to 700, more preferably 280 to 680, yet still more preferably 300 to 650.

When the epoxy resin (A) comprises the low-viscosity epoxy resin (A2) that has an epoxy equivalent of 250 to 700, the curable composition according to one embodiment of the present invention has flexibility and exhibits a large amount of displacement at a maximum strength in a bending test.

When the epoxy resin (A) comprises the low-viscosity epoxy resin (A2) that has an epoxy equivalent of 250 to 700 and a viscosity at 25 °C of 40 to 5,000 mPa·s, the curable composition according to one embodiment of the present invention can exert both of the above-described effects.

The low-viscosity epoxy resin (A2) may comprise a dibasic acid ester-type epoxy resin (A2-1).

The “dibasic acid ester-type epoxy resin (A2-1)” comprises an epoxy resin that is based on an ester of a dibasic acid (e.g., a dimer acid that is a long-chain dibasic acid, phthalic acid, or hydrogenated phthalic acid).

The dibasic acid ester-type epoxy resin (A2-1) is not particularly limited as long as it corresponds to the above-described low-viscosity epoxy resin (A2) and the epoxy resin composition intended by the present invention can be obtained.

As the dibasic acid ester-type epoxy resin (A2-1), a commercially available product can be used. Examples thereof include jER (registered trademark) 871 (dimer acid glycidyl ester) manufactured by Mitsubishi Chemical Corporation.

The low-viscosity epoxy resin (A2) may also comprise, for example, a diglycidyl ether of an alkylene oxide adduct of bisphenol A, bisphenol F, bisphenol AD or the like, a bifunctional epoxy resin used as a reactive diluent, and a monofunctional epoxy resin constituting a part of the epoxy resin.

The epoxy resin (A) comprises the low-viscosity epoxy resin (A2) in an amount of preferably 20 to 80% by mass, more preferably 30 to 75% by mass, still more preferably 40 to 70% by mass, yet still more preferably 50 to 65% by mass, based on 100% by mass of the epoxy resin (A).

When the epoxy resin (A) comprises 20 to 80% by mass of the low-viscosity epoxy resin (A2) based on 100% by mass of the epoxy resin (A), the curable composition according to one embodiment of the present invention can ensure pump dischargeability at relatively low temperatures (40 to 50 °C).

It is noted here that the low-viscosity epoxy resin (A2) does not comprise the unmodified bisphenol-type epoxy resin (A1).

The epoxy resin (A) may comprise other epoxy resin (A3) that corresponds to neither the unmodified bisphenol-type epoxy resin (A1) nor the low-viscosity epoxy resin (A2).

The other epoxy resin (A3) is not particularly limited as long as it is an epoxy resin corresponding to neither the unmodified bisphenol-type epoxy resin (A1) nor the low-viscosity epoxy resin (A2), and the curable composition intended by the present invention can be obtained.

The epoxy resin (A) may comprise the other epoxy resin (A3) in an amount of 40% by mass or less, 30% by mass, or 20% by mass or less, based on 100% by mass of the epoxy resin.

Examples of such other epoxy resin (A3) comprise: rubber-modified epoxy resins [e.g., reaction products obtained by blending a bisphenol-type epoxy resin (e.g., a diglycidyl ether of bisphenol A, bisphenol F, or bisphenol AD, or a diglycidyl ether of an alkylene oxide adduct of bisphenol A) with a butadiene-acrylonitrile-(meth)acrylic acid copolymer at a mass ratio of 1:5 to 4:1, preferably 1:3 to 3:2, and allowing these materials to react at a temperature of 80 to 180 °C]; urethane-modified epoxy resins [e.g., reaction products obtained by allowing a polyurethane prepolymer, which is prepared by adding a polyisocyanate to an end of a polyalkylene glycol, to react with a hydroxy group of an epoxy resin (at a mixing ratio of 10:90 to 50:50); for example, reaction products between a terminal NCO group-containing urethane prepolymer, which is obtained by allowing an excess amount of diisocyanate (e.g., tolylene diisocyanate or diphenylmethane diisocyanate) to react with a polytetramethylene ether glycol (having a molecular weight of 500 to 5,000), and an OH-containing epoxy resin (e.g., a diglycidyl ether of bisphenol A, or a diglycidyl ether of an aliphatic polyhydric alcohol)]; carboxy-terminated butadiene-acrylonitrile copolymer (CTBN)-modified epoxy resins [e.g., reaction products obtained by blending a bisphenol-type epoxy resin (e.g., a diglycidyl ether of bisphenol A, bisphenol F, or bisphenol AD, or a diglycidyl ether of an alkylene oxide adduct of bisphenol A) with a carboxyl-terminated butadiene-acrylonitrile copolymer rubber at a mass ratio of 1:5 to 4:1, preferably 1:3 to 3:2, and allowing these materials to react at a temperature of 80 to 180 °C]; and acrylic modified epoxy resins [e.g., reaction products obtained by allowing carboxyl groups on the surfaces of acrylic rubber particles to react with an epoxy resin (at a mixing ratio of 10:90 to 50:50)].

The epoxy resin (A) has an aromatic ring content of preferably 15 to 40% by mass, more preferably 18 to 35% by mass, still more preferably 20 to 32% by mass, yet still more preferably 25 to 30% by mass, based on 100% by mass of the epoxy resin (A).

When the aromatic ring content of the epoxy resin (A) is 15 to 40% by mass based on 100% by mass of the epoxy resin (A), the Tg, the elastic modulus, and the bending strength of the curable composition according to one embodiment of the present invention can be improved in a more balanced manner.

The curable composition according to one embodiment of the present invention may comprise, for example, 25 to 80 parts by mass of the epoxy resin (A) per 100 parts by mass of the curable composition, and comprises preferably 30 to 70 parts by mass, more preferably 35 to 65 parts by mass, still more preferably 40 to 60 parts by mass of the epoxy resin (A).

When the curable composition according to one embodiment of the present invention comprises 25 to 80 parts by mass of the epoxy resin (A) per 100 parts by mass of the curable composition, the curability and the bending strength of the curable composition according to one embodiment of the present invention can be further improved.

In the present specification, the solid rubber (B) is not particularly limited as long as it is a solid rubber-like substance and the curable composition intended by the present invention can be obtained.

In the present specification, the term “solid” as in “solid rubber” means that the rubber is solid at room temperature (23 °C). When a rubber and a liquid component coexist, the term “solid” means that the portion of the rubber excluding the liquid component is solid at room temperature (23 °C). Accordingly, even if a rubber coexists with a liquid component and is dissolved and/or swollen at room temperature, the rubber corresponds to a solid rubber when the liquid component is removed and the rubber is solid at room temperature (23 °C).

The solid rubber (B) comprises a styrene-butadiene-divinylbenzene copolymer (B1), and the curable composition according to one embodiment of the present invention can exert an advantageous effect of further improving the shower resistance while inhibiting a decrease in Tg as well as a reduction in strength (displacement at a maximum strength in a bending test) due to foaming.

The solid rubber (B) comprises the styrene-butadiene-divinylbenzene copolymer (B1) in an amount of preferably 20 to 80% by mass, more preferably 25 to 75% by mass, still more preferably 30 to 70% by mass, yet still more preferably 35 to 65% by mass, based on 100% by mass of the solid rubber (B).

The solid rubber (B) preferably further comprises at least one selected from styrene-butadiene copolymers, acrylonitrile-butadiene copolymers, ethylene-propylene-diene copolymers, isoprene polymers, and butadiene polymers.

The solid rubber (B) may comprise a styrene-butadiene copolymer (B2), and may comprise an acrylonitrile-butadiene copolymer (B3).

When the solid rubber (B) comprises the styrene-butadiene copolymer (B2), a decrease in Tg of a cured product (reinforcing material) of the curable composition according to one embodiment of the present invention is inhibited, so that reinforcing performance can be ensured and a reduction in strength (displacement at a maximum strength in a bending test) due to foaming can be inhibited.

When the solid rubber (B) comprises the acrylonitrile-butadiene copolymer (B3), the amount of displacement of the curable composition according to one embodiment of the present invention at a maximum strength in a bending test can be further increased.

The solid rubber (B1) and/or the solid rubber (B2) has an acid content of preferably 0.2 to 8% by mass, more preferably 0.3 to 6% by mass, still more preferably 0.5 to 4% by mass.

When the solid rubber (B1) and/or the solid rubber (B2) has an acid content of 0.2 to 8% by mass, the storage stability of the curable composition according to one embodiment of the present invention can be further improved.

The curable composition according to one embodiment of the present invention may comprise, for example, 10 to 100 parts by mass of the solid rubber (B) per 100 parts by mass of the epoxy resin (A), and comprises preferably 20 to 90 parts by mass, more preferably 30 to 80 parts by mass, still more preferably 40 to 70 parts by mass of the solid rubber (B).

When the curable composition according to one embodiment of the present invention comprises 10 to 100 parts by mass of the solid rubber (B) per 100 parts by mass of the epoxy resin (A), the amount of displacement of the curable composition according to one embodiment of the present invention at a maximum strength in a bending test can be further increased while the strain resistance of the curable composition is further improved.

In the present specification, the “latent curing agent (C)”, which is a curing agent of the epoxy resin (A), refers to a compound that does not substantially function as a curing agent at room temperature but functions as a curing agent when heated (e.g., to 165 °C, preferably 150 °C), and the latent curing agent (C) is not particularly limited as long as the curable composition intended by the present invention can be obtained.

Specific examples of the latent curing agent comprise: dicyandiamide; dihydrazide compounds, such as adipic acid dihydrazide, sebacic acid dihydrazide, isophthalic acid dihydrazide, dodecanediohydrazide, 1,3-bis(hydrazinocarboethyl)-5-isopropylhydantoin, eicosanedioic acid dihydrazide, hydroquinone diglycolic acid dihydrazide, resorcinol diglycolic acid dihydrazide, and 4,4′-ethylidenebisphenol diglycolic acid dihydrazide; 4,4′-diaminodiphenyl sulfone; imidazole compounds, such as imidazole, 2-n-heptadecylimidazole, and 2-undecylimidazole; melamine; triazine compounds, such as 2,4-diamino-6-(2′-methylimidazolyl(1′))-ethyl-o-triazine; benzoguanamine; dialkyl urea compounds, for example, N,N-dialkyl urea such as N,N-dimethyl-N-(3,4-dichlorophenyl)urea, and N,N-dialkyl urea compounds; N,N-dialkyl thiourea compounds; polyamines, such as diaminodiphenylmethane, diaminobiphenyl, diaminophenyl, phenylenediamine, tolylenediamine, dodecanediamine, decanediamine, octanediamine, tetradecanediamine, hexadecanediamine, polyoxypropylenediamine, and hydrazide-based polyamines; and guanidine derivatives such as cyanoguanidine.

As the latent curing agent, a commercially available product can be used. Examples thereof comprise CG-NA (trade name) manufactured by Air Products Ltd., EH-4030s (trade name) manufactured by ADEKA Corporation, ADH (trade name) manufactured by Otsuka Chemical Co., Ltd., EH3731s (trade name) manufactured by ADEKA Corporation, DYHARD UR200 (trade name) manufactured by AlzChem Group AG, and DDH (trade name) manufactured by Otsuka Chemical Co., Ltd.

The curable composition according to one embodiment of the present invention may comprise, for example, 1 to 30 parts by mass of the latent curing agent (C) per 100 parts by mass of the epoxy resin, and comprises preferably 2 to 25 parts by mass, more preferably 3 to 20 parts by mass, still more preferably 4 to 15 parts by mass of the latent curing agent (C).

When the curable composition according to one embodiment of the present invention comprises 1 to 30 parts by mass of the latent curing agent (C) per 100 parts by mass of the epoxy resin, the curable composition has a superior balance of curability and storage stability.

In the present specification, the filler (D) is a compound that not only increases the amount of the curable composition according to one embodiment of the present invention but also can impart a certain degree of strength to a cured product formed from the curable composition, and the filler (D) is not particularly limited as long as it can contribute to viscosity adjustment or weight reduction depending on the case, and the curable composition intended by the present invention can be obtained.

Examples of the filler comprise: carbonates and sulfates of alkaline earth metals, such as calcium carbonate (e.g., heavy calcium carbonate, precipitated calcium carbonate, and surface-treated calcium carbonate), magnesium carbonate and barium sulfate; mica, graphite, talc, clay, glass flakes (glass beads), vermiculite, kaolinite, wollastonite (acicular calcium metasilicate), silica, diatomaceous earth, gypsum, cement, converter slag, Shirasu, zeolite, cellulose powder, powdered rubber, xonotlite, potassium titanate, bentonite, aluminum nitride, silicon nitride, zinc white, titanium oxide, alumina, zinc oxide, iron oxide, magnesium oxide, titanium oxide, magnesium hydroxide, aluminum hydroxide, and calcium silicate; calcium carbonate whiskers (acicular calcium carbonate), ceramic short fibers or whiskers thereof, rock wool short fibers, glass short fibers, potassium titanate short fibers, calcium silicate short fibers, aluminum silicate, carbon short fibers, aramid short fibers, mineral fibers of sepiolite and the like; fibrous fillers, such as various whiskers; hollow fillers, such as glass balloons, silica balloons, resin balloons, and carbon inorganic hollow spheres; organic hollow fillers, for example, plastic balloons made of an organic synthetic resin such as vinylidene chloride or acrylonitrile; and metallic fillers such as aluminum fillers.

The filler (D) preferably comprises a needle-like filler having a length of 0.4 mm or more, more preferably comprises a needle-like filler having a length of 0.4 mm to 40 mm, still more preferably comprises a needle-like filler having a length of 5 mm to 30 mm, yet still more preferably comprises a needle-like filler having a length of 6 mm to 20 mm.

When the filler (D) comprises a needle-like filler having a length of 0.4 mm or more, the strain resistance of the curable composition according to one embodiment of the present invention can be further improved.

The filler (D) preferably comprises an inorganic filler having an aspect ratio (L/D) of 4 or higher, more preferably comprises an inorganic filler having an aspect ratio (L/D) of 4.5 to 20, still more preferably comprises an inorganic filler having an aspect ratio (L/D) of 5 to 15.

When the filler (D) comprises an inorganic filler having an aspect ratio (L/D) of 4 or higher, the strain resistance of the curable composition according to one embodiment of the present invention can be further improved.

Examples of the inorganic filler include the above-exemplified fillers, excluding organic fillers (e.g., rock wool short fibers, aramid short fibers, hollow fillers such as resin balloons, and organic hollow fillers, for example, plastic balloons made of an organic synthetic resin such as vinylidene chloride or acrylonitrile).

The curable composition according to one embodiment of the present invention may comprise, for example, 20 to 70 parts by mass of the filler (D) per 100 parts by mass of the curable composition, and comprises preferably 35 to 65 parts by mass, more preferably 30 to 60 parts by mass, still more preferably 35 to 55 parts by mass of the filler (D).

When the curable composition according to one embodiment of the present invention comprises 20 to 70 parts by mass of the filler (D) per 100 parts by mass of the curable composition, the strain resistance of the curable composition can be further improved.

In the present specification, the “foaming agent (E)” refers to a substance that is added for the purpose of increasing the volume of a material, for example, a substance added for foam generation, and the foaming agent (E) is not particularly limited as long as it is, for example, a substance that generates a gas by decomposition or a substance that itself becomes a gas, and the curable composition intended by the present invention can be obtained.

Since the curable composition according to one embodiment of the present invention comprises a foaming agent, the post-curing thickness can be increased more efficiently, and the reinforcing performance can be improved. Further, as a result of foaming, the elastic modulus of a cured product (i.e., reinforcing material) obtained by curing the curable composition can be reduced, and the strain can be reduced as well.

The foaming agent (E) is preferably, for example, a foaming agent that foams when heated, and examples thereof comprise inorganic foaming agents and organic foaming agents.

Examples of the inorganic foaming agents comprise ammonium carbonate, ammonium hydrogen carbonate, sodium hydrogen carbonate, ammonium nitrite, sodium borohydride, and azides.

Examples of the organic foaming agents comprise n-nitroso compounds, azo compounds (e.g., azodicarbonamide: ADCA), fluorinated alkanes, hydrazine compounds (e.g., 4,4′-oxybis(benzenesulfonylhydrazide): OBSH), semicarbazide compounds, and triazole compounds.

Examples of the foaming agent (E) further comprise heat-expandable particles (unexpanded balloons) in which a heat-expandable substance (e.g., isobutane or butane) is encapsulated in microcapsules made of a thermoplastic resin (e.g., polyvinylidene chloride, polyacrylonitrile, or poly(meth)acrylic acid ester).

The foaming agent (E) preferably comprises at least one selected from the group consisting of azo compounds (e.g., ADCA-type chemical foaming agents), hydrazine compounds (e.g., OBSH-type chemical foaming agents), and unexpanded balloons.

When the foaming agent (E) comprises at least one selected from the group consisting of azo compounds (e.g., ADCA-type chemical foaming agents), hydrazine compounds (e.g., OBSH-type chemical foaming agents), and unexpanded balloons, the curable composition according to one embodiment of the present invention can further improve the bending strength and further reduce the strain while attaining a desired foaming ratio.

The curable composition according to one embodiment of the present invention may comprise, for example, 0.1 to 10 parts by mass of the foaming agent (E) per 100 parts by mass of the curable composition, and comprises preferably 0.2 to 5 parts by mass, more preferably 0.3 to 3 parts by mass, still more preferably 0.4 to 2 parts by mass of the foaming agent (E).

When the curable composition according to one embodiment of the present invention comprises 0.1 to 10 parts by mass of the foaming agent (E) per 100 parts by mass of the curable composition, the curable composition can be foamed more appropriately, and can ensure superior reinforcing performance while further reducing the strain.

The curable composition according to one embodiment of the present invention may comprise other components as appropriate. Examples of the other components comprise ordinary curing agents (excluding the above-described latent curing agent), diluents, surfactants, and other additives.

In one embodiment of the present invention, a curing agent is a compound that does not have a curing action at normal temperature but exhibits a curing action at a certain temperature, and is not particularly limited as long as the curable composition intended by the present invention can be obtained, except for the above-described latent curing agent.

In one embodiment of the present invention, a diluent is not particularly limited as long as it can impart fluidity to the curable composition according to one embodiment of the present invention, and the curable composition intended by the present invention can be obtained.

Examples of the diluent comprise hydrocarbon-based solvents, such as paraffinic solvents, isoparaffinic solvents, naphthenic solvents, and aromatic solvents.

In one embodiment of the present invention, examples of the other additives comprise moisture absorbents (e.g., calcium oxide and molecular sieves), thixotropic agents (e.g., organic bentonite, fumed silica, aluminum stearate, metallic soaps, and castor oil derivatives), stabilizers [e.g., 2,6-di-t-butyl-4-methylphenol, 2,2-methylene-bis(4-methyl-6-t-butylphenol), and nickel dibutyldithiocarbamate], curing accelerators (e.g., dibutyltin dilaurate, lead octylate, and bismuth octylate), coupling agents such as silane and titanium, and plasticizers. The other additives are not particularly limited and can be used as appropriate, as long as the curable composition intended by the present invention can be obtained.

The curable composition according to one embodiment of the present invention can be produced by mixing the above-described components.

A mixing apparatus and a mixing method are not particularly limited as long as the curable composition intended by the present invention can be produced.

As the mixing apparatus, specifically, for example, a twin-screw mixer, a planetary mixer, a sigma mixer, a kneader, an attritor, a Glen mill, a roll, or a dissolver can be used.

The mixing can be performed using a container in which the components can be mixed, for example, in a tank, a vessel, or the like.

The curable composition according to one embodiment of the present invention may be of a one-pack type (or one-liquid type) or a two-pack type (or two-liquid type) and can be generally used as a one-pack (or two-liquid) curable composition.

The curable composition according to one embodiment of the present invention can be applied to a required place in any thickness and form by using a known coating method such as bead coating, slit coating, spray coating, swirl coating, or shot coating, and can be cured by, for example, heating to a prescribed temperature using a hot-air circulation drying oven.

The curable composition according to one embodiment of the present invention can be used as a coating-type one-pack curable composition.

In the above-described coating method, coating can be performed by a computer-controlled automatic coating machine or a robot coating machine.

In one embodiment of the present invention, an automobile production method that comprises the use of the curable composition according to one embodiment of the present invention can be provided.

The curable composition according to one embodiment of the present invention can be used in a production line for automobile production so as to provide a reinforcing layer on an automobile body sheet metal. In other words, an automobile body sheet metal can be provided with a reinforcing layer by applying and heat-curing thereon the curable composition according to one embodiment of the present invention. Further, a reinforced sheet metal structure which comprises a reinforcing layer formed by applying and heat-curing the curable composition according to one embodiment of the present invention on an automobile body sheet metal, and a method of producing the same can be provided.

Moreover, a curable composition which is used for sheet metal reinforcement and is pump-dischargeable can be provided.

The curable composition according to one embodiment of the present invention has a viscosity of preferably 50 to 300 Pa·s, more preferably 65 to 250 Pa·s, still more preferably 80 to 200 Pa·s, yet still more preferably 90 to 180 Pa·s, at a temperature of 40 °C and a shear rate of 430 sec⁻¹.

When the viscosity of the curable composition according to one embodiment of the present invention is 50 to 300 Pa·s at a temperature of 40 °C and a shear rate of 430 sec⁻¹, the pump dischargeability of the curable composition according to one embodiment of the present invention can be further improved.

The curable composition according to one embodiment of the present invention has a foaming ratio of preferably 10 to 200%, more preferably 30 to 150%.

When the foaming ratio of the curable composition according to one embodiment of the present invention is 10 to 200%, the reinforcing performance and the strain resistance of the curable composition according to one embodiment of the present invention can be further improved.

A cured product of the curable composition according to one embodiment of the present invention has a bending strength of preferably 18 N or more, more preferably 20 to 60 N, still more preferably 22 to 50 N, yet still more preferably 24 to 40 N.

When the bending strength of a cured product of the curable composition according to one embodiment of the present invention is 18 N or more, the curable composition according to one embodiment of the present invention can exhibit a further improved reinforcing performance.

A cured product of the curable composition according to one embodiment of the present invention has a displacement (bending) of preferably 4.5 mm or more, more preferably 4.8 to 20 mm, still more preferably 5 to 17 mm, yet still more preferably 5.5 to 15 mm.

When the bending of a cured product of the curable composition according to one embodiment of the present invention is 4.5 mm or more, the curable composition according to one embodiment of the present invention does not crack even at impact, and can further ensure the reinforcing performance.

A cured product of the curable composition according to one embodiment of the present invention has a warpage of preferably 5 mm or less, more preferably −1 to 4 mm, still more preferably −0.5 to 3.5 mm, yet still more preferably 0 to 3 mm.

When the warpage of a cured product of the curable composition according to one embodiment of the present invention is 5 mm or less, the curable composition according to one embodiment of the present invention can further inhibit the distortion of a reinforcing panel.

A cured product of the curable composition according to one embodiment of the present invention has an elastic modulus of preferably 1,000 to 3,000 MPa, more preferably 1,100 to 2,500 MPa, still more preferably 1,200 to 2,000 MPa, yet still more preferably 1,300 to 1,800 MPa.

When the elastic modulus of a cured product of the curable composition according to one embodiment of the present invention is 1,000 to 3,000 MPa, the reinforcing performance of the curable composition according to one embodiment of the present invention can be further improved.

A cured product of the curable composition according to one embodiment of the present invention has a Tg of preferably 40 to 140 °C, more preferably 50 to 120 °C, still more preferably 60 to 100 °C, yet still more preferably 70 to 95 °C.

When the Tg of a cured product of the curable composition according to one embodiment of the present invention is 40 to 140 °C, the reinforcing performance of the curable composition according to one embodiment of the present invention can be further improved.

### EXAMPLES

The present invention will now be described more concretely and in more detail by way of Examples and Comparative Examples; however, the below-described Examples are merely embodiments of the present invention, and the present invention is not limited by the below-described Examples at any rate.

In the description of Examples, unless otherwise specified, portions where a solvent is not taken into account are bases on parts by mass or % by weight.

Components used in the present Examples are shown below.

### (A) Epoxy Resin

(a1-1) Unmodified bisphenol A-type epoxy resin (jER828 (trade name), manufactured by Mitsubishi Chemical Corporation)
(a1-2) Unmodified bisphenol A-type epoxy resin (jER1001 (trade name), manufactured by Mitsubishi Chemical Corporation)
(a1-3) Unmodified bisphenol F-type epoxy resin (jER807 (trade name), manufactured by Mitsubishi Chemical Corporation)
(a2-1) Low-viscosity epoxy resin having an epoxy equivalent of 430 and a viscosity of 600 mPa·s at 25 °C, dimer acid-type diglycidyl ester (jER871 (trade name), manufactured by Mitsubishi Chemical Corporation)
(a2-2) Polyoxyalkylene bisphenol A glycidyl ether having an epoxy equivalent of 340 and a viscosity of 2,600 mPa·s at 25 °C (GLYCI-ALE BPP-350 (trade name), manufactured by Sanyo Chemical Industries, Ltd.)
(a2-3) Bifunctional epoxy resin used as a reactive diluent, having an epoxy equivalent of 296 and a viscosity of 43 mPa·s at 25 °C (PP-300P (trade name), manufactured by Sanyo Chemical Industries, Ltd.)
(a3-1) Elastomer-modified epoxy resin (bisphenol A-type epoxy resin modified at an elastomer content of 40%), having an epoxy equivalent of 340 and a viscosity of 190,000 mPa·s at 25 °C (HYPRO RA840 (trade name), manufactured by CVC Thermoset Specialties, Inc.))

### (B) Solid Rubber

(b1-1) Styrene-butadiene-divinylbenzene copolymer (EMULPRENE 1009 (trade name), manufactured by Industrias Negromex, S.A. de C.V.)
(b2-1) Styrene-butadiene copolymer (NIPOL 1502 (trade name), manufactured by Zeon Corporation)
(b3-1) Acrylonitrile-butadiene copolymer (DN214 (trade name), manufactured by Zeon Corporation)
(b3-2) Acrylonitrile-butadiene copolymer (DN219 (trade name), manufactured by Zeon Corporation)

### (C) Latent Curing Agent

(c1) Dicyandiamide (OMICURE DDA 10 (trade name), manufactured by CVC Thermoset Specialties, Inc.)
(c2) 3-(3,4-dichlorophenyl)-1,1-dimethyl urea (DYHARD UR-200 (trade name), manufactured by AlzChem Group AG)

### (D) Filler

(d1) Carbon black (#20 (trade name), manufactured by Asahi Carbon Co., Ltd.)
(d2) Glass balloon (GLASS BUBBLE S-38 (trade name), manufactured by 3M Company)
(d3) Filler (WHITON B (trade name), manufactured by Bihoku Funka Kogyo Co., Ltd.)
(d4) Filler (HAKUENKA CCR (trade name), manufactured by Shiraishi Kogyo Kaisha, Ltd.)
(d5) Calcium metasilicate, L/D ratio > or =5 (NYAD G (trade name), manufactured by NYCO Minerals, Inc.)

### (E) Foaming Agent

(e1) Foaming agent (VINYFOR AC #R (trade name), manufactured by Eiwa Chemical Ind. Co., Ltd.)
(e2) Foaming agent (NEOCELLBORN #1000M (trade name), manufactured by Eiwa Chemical Ind. Co., Ltd.)
(e3) Foaming agent (EXPANCEL 920-80 (trade name), manufactured by Japan Fillite Co., Ltd.)

### (F) Additive

(f1) Additive, calcium oxide, QC-X (trade name) manufactured by Inoue Calcium Corporation

These components were blended in the respective amounts (parts by mass) shown in Tables 1-3 to produce one-pack curable compositions of Examples 1 to 12 and Comparative Examples 1 to 5.

For each of the thus obtained curable compositions (or cured products thereof), the viscosity, the shower resistance, the foaming ratio, the bending strength, the amount of displacement (bending), the amount of warpage, the elastic modulus, and the Tg were measured and evaluated by the below-described respective methods. The results thereof are shown in Tables 1-3.

### Measurement of Viscosity

The viscosity of each curable composition was measured using a pressure-type apparent viscometer in accordance with JAS0323-77. The cylinder of the viscometer was filled with each curable composition, and the temperature was adjusted to 40 °C using a jacket or the like. The temperature was confirmed to be 40 °C. A No. 3 capillary (length: 74.1 mm, capillary diameter: 1.85 mm) was used. The measurement was performed at a shear rate of 430 s⁻¹. The viscosity range in which each curable composition can be applied is believed to be 300 Pa·s or less, and the viscosity of each curable composition is preferably 50 Pa·s to 300 Pa·s.

### Shower Resistance

A test piece was prepared by applying each curable composition to a 200 mm×300 mm×0.8 mm SPCC-SD steel sheet to be an amount of 150 mm×200 mm×1.8 mm. To the surface of the test piece thus coated with the curable composition, a shower of water having a temperature of 50 °C was applied at an angle of 450 and a water pressure of 490 kPa. The distance from a shower nozzle to the test piece was 700 mm, and the shower was applied for 1 minute. Thereafter, the coated surface was visually observed to check the presence or absence of detachment or displacement of the curable composition. The evaluation criteria for the shower resistance were as follows.
⊚: The curable composition was absolutely not detached or displaced.
∘: The curable composition was not detached or displaced.
∘Δ: The curable composition was very slightly detached or displaced, but did not present a problem.
Δ: The curable composition was slightly detached or displaced, but did not present a problem in practical use.
Δx: The curable composition was slightly detached or displaced, which presented a problem in practical use.
x: The curable composition was clearly detached or displaced.

### Foaming Ratio

A test specimen was prepared by applying each curable composition in a bead shape to a 3 cm×7 cm aluminum plate. The test specimen was measured in accordance with a water displacement method (see JAS0323-77 Specific Gravity Test Method A), and the foaming ratio was calculated from the density (specific gravity) of the curable composition before and after curing.

Foaming ratio (%)=(Reciprocal of post-curing density−Reciprocal of pre-curing density)+Reciprocal of pre-curing density×100

The curable composition was cured by placing the test specimen in a forced circulation-type oven at 180 °C for 25 minutes. From the standpoint of the reinforcing performance and the curing strain of a cured product of each curable composition, the foaming ratio is preferably 10 to 200%, more preferably 30 to 150%.

### Bending Strength and Amount of Displacement (Bending)

Each curable composition was applied to a 25 mm×200 mm×0.8 mm SPCC-SD steel sheet in a thickness of 1.8 mm, and the thus coated steel sheet was subsequently placed in a force circulation-type oven to cure the curable composition at 180 °C for 25 minutes, whereby a test specimen was obtained. A three-point bending test of this test specimen was conducted using a bending strength tester prescribed in JIS K6911 under the conditions of a fulcrum distance of 100 mm and a load speed of 1 mm/min, and the load (N/25 mm) at 1-mm displacement and the amount of displacement at a maximum load were measured to determine the bending strength and the bending. Taking into consideration the dent resistance on an actual vehicle, the load (bending strength) at 1-mm displacement is preferably 18 N or more, and the amount of displacement (bending) at a maximum load is preferably 4.5 mm or more.

### Amount of Warpage

Each curable composition was applied to a 25 mm×200 mm×0.8 mm SPCC-SD steel sheet in a thickness of 1.8 mm, and the thus coated steel sheet was subsequently placed in a force circulation-type oven to cure the curable composition at 180 °C for 25 minutes, whereby a test specimen was obtained. A weight of 1 kg-f was placed on one side of this test specimen, and the warpage height (mm) on the opposite side was measured. Taking into consideration the amount of warpage that does not lead to a poor appearance on an actual vehicle, the amount of warpage is preferably 5 mm or less.

### Elastic Modulus and Tg

To a 0.8-mm aluminum plate that had been subjected to a release treatment such as TEFLON (registered trademark) coating, each curable composition was applied such that the post-curing thickness was 1 to 2 mm, and the resulting coated test piece was subsequently placed in a force circulation-type oven to cure the curable composition at 180 °C for 25 minutes, whereby a cured product was obtained. This cured product was processed into a size of 5 mm in width and 50 mm in length and, using a dynamic viscoelastic analysis (DMA) device, the elastic modulus and the tan δ were measured at a heating rate of 2 °C/min in a range of −50 to 150 °C. The elastic modulus at 23 °C and the temperature showing a peak position of tan δ as Tg were recorded. From the standpoint of the dent resistance on an actual vehicle and the use temperature environment, it is preferred that both an elastic modulus of 1,000 to 3,000 MPa and a Tg of 40 °C to 140 °C be satisfied.

TABLE 1

| | | Example | | | | | |
|---|---|---|---|---|---|---|---|
| | | 1 | 12 | 3 | 4 | 5 | 6 |
| (A) | (a1-1) | 17 | 15 | 17 | 17 | 23 | 13 |
| | (a1-2) | | 4 | | | | |
| | (a1-3) | | | | | | |
| | (a2-1) | 13 | 14 | 13 | 13 | 10 | 15 |
| | (a2-2) | 13 | 14 | 13 | 13 | 10 | 15 |
| | (a2-3) | | | | | | |
| | (a3-1) | | | | | | |
| (B) | (b1) | 5 | 3 | 3 | 7 | 5 | 5 |
| | (b2-1) | | | | | | |
| | (b3-1) | 5 | 3 | 5 | 3 | 5 | 5 |
| | (b3-2) | | | 2 | | | |
| (C) | (c1) | 3 | 3 | 3 | 3 | 3 | 3 |
| | (c2) | 1 | 1 | 1 | 1 | 1 | 1 |
| (D) | (d1) | 2 | 2 | 2 | 2 | 2 | 2 |
| | (d2) | 5 | 5 | | 5 | | |
| | (d3) | 2.5 | 2.5 | 7.5 | 2.5 | 7.4 | 7.5 |
| | (d4) | | | | | | |
| | (d5) | 33 | 33 | 33 | 33 | 33 | 33 |
| (E) | (e1) | 0.5 | 0.5 | 0.5 | 0.5 | 0.6 | 0.5 |
| | (e2) | | | | | | |
| | (e3) | | | | | | |
| (F) | (f1) | | | | | | |

| | | | | | | | |
|---|---|---|---|---|---|---|---|
| Total | | 100.0 | 100.0 | 100.0 | 100.0 | 100.0 | 100.0 |
| Aromatic ring content in (A) | % by mass | 25.9 | 26.6 | 25.9 | 25.9 | 30.7 | 22.7 |
| Content of (A1) | % by mass | 40 | 40 | 40 | 40 | 53 | 30 |
| Content (B) based on (A) | parts by mass | 23 | 13 | 23 | 23 | 23 | 23 |
| Coating thickness | mm | 1.8 | 1.8 | 1.8 | 1.8 | 1.8 | 1.8 |
| Viscosity | Pa · s | 106 | 100 | 80 | 120 | 140 | 80 |
| Shower resistance | | ⊚ | ∘Δ | ∘ | ⊚ | ⊚ | ⊚ |
| Foaming ratio | % | 57 | 60 | 60 | 55 | 60 | 60 |
| Bending strength | N | 24 | 33 | 30 | 28 | 35 | 23 |
| Amount of displacement (bending) | nm | 6.5 | 4.8 | 4.8 | 5.8 | 5.8 | 8.5 |
| Amount of warpage | mm | 0.67 | 3 | 0.8 | 0.7 | 3.5 | 0.3 |
| Elastic modulus | IMPa | 1,602 | 1,900 | 1,600 | 1,700 | 2,200 | 1,200 |
| Tg | °C | 77 | 81 | 73 | 82 | 88 | 72 |

TABLE 2

| | | Example | | | | | |
|---|---|---|---|---|---|---|---|
| | | 7 | 8 | 9 | 10 | 11 | 12 |
| (A) | (a1-1) | 17 | 17 | 17 | 17 | | 10 |
| | (a1-2) | | | | | | |
| | (a1-3) | | | | | 17 | |
| | (a2-1) | 13 | 13 | 13 | 13 | 13 | 13 |
| | (a2-2) | 13 | 13 | 13 | 13 | 13 | 13 |
| | (a2-3) | | | | | | |
| | (a3-1) | | | | | | 7 |
| (B) | (b1) | 5 | 5 | 5 | 5 | 5 | 5 |
| | (b2-1) | | | | | | |
| | (b3-1) | 5 | 5 | 5 | 5 | 5 | 5 |
| | (b3-2) | | | | | | |
| (C) | (c1) | 3 | 3 | 3 | 3 | 3 | 3 |
| | (c2) | 1 | 1 | 1 | 1 | 1 | 1 |
| (D) | (d1) | 2 | 2 | 2 | 2 | 2 | 2 |
| | (d2) | 5 | 5 | | | 5 | 5 |
| | (d3) | 2 | 1 | 7.5 | 7.5 | 2.5 | 2.5 |
| | (d4) | | | | | | |
| | (d5) | 33 | 33 | 33 | 33 | 33 | 33 |
| (E) | (e1) | 1 | 2 | | | 0.5 | 0.5 |
| | (e2) | | | 0.5 | | | |
| | (e3) | | | | 0.5 | | |
| (F) | (f1) | | | | | | |

| | | | | | | | |
|---|---|---|---|---|---|---|---|
| Total | | 100.0 | 100.0 | 100.0 | 100.0 | 100.0 | 100.0 |
| Aromatic ring content in (A) | % by mass | 25.9 | 25.9 | 25.9 | 25.9 | 27.4 | 18.3 |
| Content of (A1) | % by mass | 40% | 40% | 40% | 40% | 40% | 32% |
| Content (B) based on (A) | parts by mass | 23% | 23% | 23% | 23% | 23% | 23% |
| Coating thickness | mm | 1.8 | 1.8 | 1.8 | 1.8 | 1.8 | 1.8 |
| Viscosity | Pa · s | 100 | 100 | 100 | 100 | 80 | 140 |
| Shower resistance | | ⊚ | ⊚ | ⊚ | ⊚ | ⊚ | ⊚ |
| Foaming ratio | % | 80 | 120 | 50 | 65 | 55 | 62 |
| Bending strength | N | 28 | 30 | 21 | 22 | 20 | 21 |
| Amount of displacement (bending) | mm | 5.5 | 4.5 | 5 | 5 | 7.2 | 7.5 |
| Amount of warpage | mm | 0.5 | 0.5 | 0.8 | 0.7 | 0.5 | 0.5 |
| Elastic modulus | MPa | 1,200 | 1,000 | 1,450 | 1,500 | 1,200 | 1,150 |
| Tg | °C | 74 | 73 | 73 | 77 | 72 | 70 |

TABLE 3

| | | Comparative Example | | | | |
|---|---|---|---|---|---|---|
| | | 1 | 12 | 3 | 4 | 5 |
| (A) | (a1-1) | 17 | 17 | 17 | | 29 |
| | (a1-2) | | | | | |
| | (a1-3) | | | | | |
| | (a2-1) | 13 | 13 | 13 | 23 | |
| | (a2-2) | 13 | 13 | 13 | 20 | |
| | (a2-3) | | | | | 17 |
| | (a3-1) | | | | | |
| (B) | (b1) | 5 | 5 | | 5 | |
| | (b2-1) | | | 4 | | |
| | (b3-1) | 5 | 5 | 6 | 5 | 5 |
| | (b3-2) | | | | | |
| (C) | (c1) | 3 | 3 | 3 | 3 | 3 |
| | (c2) | 1 | 1 | 1 | 1 | 1 |
| (D) | (d1) | 2 | 2 | 2 | 2 | |
| | (d2) | | | 5 | | |
| | (d3) | 8 | 8 | 2.5 | 7.7 | |
| | (d4) | | | | | 8 |
| | (d5) | 33 | 33 | 33 | 33 | 36 |
| (E) | (e1) | | | 0.5 | 0.3 | |
| | (e2) | | | | | |
| | (e3) | | | | | |
| (F) | (f1) | | | | | 1 |

| | | | | | | |
|---|---|---|---|---|---|---|
| Total | | 100.0 | 100.0 | 100.0 | 100.0 | 100.0 |
| Aromatic ring content in (A) | % by mass | 25.9 | 25.9 | 25.9 | 11.3 | 29.5 |
| Content of (A1) | % by mass | 40% | 40% | 40% | 0% | 63% |
| Content (B) based on (A) | parts by mass | 23% | 23% | 23% | 23% | 11% |
| Coating thickness | mm | 1.8 | 2.5 | 1.8 | 1.8 | 1.8 |
| Viscosity | Pa · s | 95 | 95 | 60 | 40 | 30 |
| Shower resistance | | ⊚ | ⊚ | Δ-x | Δ | ∘Δ |
| Foaming ratio | % | 0 | 0 | 60 | 60 | 0 |
| Bending strength | N | 17 | 36 | 27 | 11 | 22 |
| Amount of displacement (bending) | mm | 7 | 5 | 4.2 | 12 | 3.2 |
| Amount of warpage | mm | 3 | 14 | 1 | 0 | 5 |
| Elastic modulus | MPa | 2,600 | 2,600 | 1,800 | 100 | 2,300 |
| Tg | °C | 75 | 75 | 80 | 10 | 85 |

The curable compositions of Examples 1 to 12 and cured products thereof can each be used as a pump-dischargeable one-pack curable composition for sheet metal reinforcement, which not only can improve the reinforcing performance while reducing the strain but also can improve the shower resistance while maintaining the pump dischargeability.

The curable compositions of Comparative Examples 1 to 5 and cured products thereof are not considered to be sufficient as one-pack curable compositions for coating since they can neither improve the reinforcing performance while reducing the strain nor improve the shower resistance while maintaining the pump dischargeability.

### INDUSTRIAL APPLICABILITY

The one-pack curable composition according to one embodiment of the present invention not only can improve the reinforcing performance while reducing the strain but also can improve the shower resistance while maintaining the pump dischargeability. Further, the one-pack curable composition can be preferably applied to a sheet metal, and can thus be preferably used as a coating-type sheet metal reinforcing material.

1. A one-pack curable composition, comprising:
(A) an epoxy resin;
(B) a solid rubber;
(C) a latent curing agent;
(D) a filler; and
(E) a foaming agent,
wherein
the epoxy resin (A) comprises an unmodified bisphenol-type epoxy resin (A1),
the one-pack curable composition comprises 10 to 100 parts by mass of the solid rubber (B) per 100 parts by mass of the epoxy resin (A), and
the solid rubber (B) comprises a styrene-butadiene-divinylbenzene copolymer (B1).

2. The one-pack curable composition according to claim 1, having a viscosity of 50 to 300 Pa·s at a temperature of 40 °C and a shear rate of 430 sec⁻¹.

3. The one-pack curable composition according to claim 1, wherein the epoxy resin (A) comprises 25 to 90% by mass of the unmodified bisphenol-type epoxy resin (A1) based on 100% by mass of the epoxy resin.

4. The one-pack curable composition according to claim 1, wherein the epoxy resin (A) comprises 15 to 40% by mass of an aromatic ring based on 100% by mass of the epoxy resin.

5. The one-pack curable composition according to claim 1, wherein the foaming agent (E) comprises at least one selected from the group consisting of ADCA-type chemical foaming agents, OBSH-type chemical foaming agents, and unexpanded balloons.

6. The one-pack curable composition according to claim 1, having a foaming ratio of 10 to 200%.

7. The one-pack curable composition according to claim 1, wherein the filler (D) comprises a needle-like filler having a length of 0.5 mm or more.

8. The one-pack curable composition according to claim 1, wherein the solid rubber (B) further comprises a styrene-butadiene copolymer (B2).

9. The one-pack curable composition according to claim 1, wherein the solid rubber (B) further comprises a nitrile-butadiene copolymer (B3).

10. The one-pack curable composition according to claim 1, wherein the solid rubber (B1) and/or the solid rubber (B2) have an acid content of 0.2 to 8% by mass.

11. The one-pack curable composition according to claim 1, wherein
the epoxy resin (A) comprises a low-viscosity epoxy resin (A2), and
the low-viscosity epoxy resin (A2) has an epoxy equivalent of 250 to 700, and a viscosity of 40 to 5,000 mPa·s at 25 °C.

12. The one-pack curable composition according to claim 11, wherein the low-viscosity epoxy resin (A2) comprises a dibasic acid ester-type epoxy resin (A2-1).

13. The one-pack curable composition according to claim 1, wherein the filler (D) comprises an inorganic filler having an aspect ratio (L/D) of 5 or higher.

14. The one-pack curable composition according to claim 1, which is of a coating type.

15. The one-pack curable composition according to claim 1, which is used for sheet metal reinforcement and is pump-dischargeable.
